(19) United States
(12) Patent Application Publication
(10) Pub. No.: US 2009/0245078 A1
(43) Pub. Date: Oct. 1, 2009

(54) LUBRICANT FOR DATA SENSING INTERFACE AND METHOD OF LUBRICATION

(75) Inventors: Paul Max Jones, Pittsburgh, PA (US); Corina Nistorica, San Jose, CA (US); Yiao Tee Hsia, Wexford, PA (US)

Correspondence Address: SEAGATE TECHNOLOGY LLC;C/O WESTMAN, CHAMPLIN & KELLY, P.A., SUITE 1400, 900 SECOND AVENUE SOUTH, MINNEAPOLIS, MN, 55402-3244, US

(73) Assignee: Seagate Technology LLC, Scotts Valley, CA (US)

(21) Appl. No.: 12/055,803

(22) Filed: Mar. 26, 2008

(51) Int. Cl. G11B 3/00

(52) U.S. Cl. 369/173

(57) ABSTRACT

A data sensing interface comprising a surface of a recording medium and a tip of a data sensor positioned to sense data stored on the recording medium and a layer of polyphenyl ether disposed between the tip and the surface to function as a lubricant. A method of reducing wear within the data sensing interface includes providing a layer of polyphenyl ether between the tip of the data sensor and the surface of the recording medium to act as a lubricant.

### BACKGROUND

Many modern information storage systems depend on ferroelectric recording due to its reliability, low cost, and high storage capacity. One such data storage system is known as a probe storage system which reads and writes information from and to ferroelectric media.

A read-write head in the form of a probe is used to make contact with the surface of the ferroelectric media. During the act of write-reading, the tip of the probe is extended over the medium and comes in contact across the surface of the medium in a controlled manner. The medium and the tip of the probe experience high speeds in search for data on the ferroelectric medium.

Intimate contact of the tip with the medium is necessary for reading of the data. The contact between the tip of the probe and the medium is generally considered a high contact pressure situation, resulting in high friction and large wear rates, on the storage medium. The high contact pressure also manifests in high interface temperatures, temperatures in the area between the tip and the storage medium.

Another problem that occurs during the write-read operation are current leaks that exist through the interface between the tip and the storage medium which increase the interface temperature through joule heating and which provides a source of electron flow through the interface. Because of the high contact pressure, high interface temperatures and electron flow, high wear rates especially in the storage medium have been observed.

There have been attempts to supply lubricants to the interface between the tip and the media surface. However, such attempts have had problems in that the lubricants used tend to polymerize due to the conditions found in the interface thereby leading to a large reduction in the lubricant thickness, an increase in the lubricant's average molecular weight and viscosity and in some cases an eventual gel being formed. The increase in average molecular weight, viscosity and in the cases in which a gel is formed result in a sticky product which adversely impacts the functioning of the tip in its write-read function of the storage medium.

### SUMMARY

A data sensing interface comprises a surface of a recording medium and a tip of a data sensor disposed to sense data stored on the recording medium and a layer of polyphenyl ether disposed between the tip and the surface for functioning as a lubricant.

A method of reducing wear within a data sensing interface provides a layer of polyphenyl ether between a tip of a data sensor and a surface of a recording medium such that the polyphenyl ether acts as a lubricant when the tip of the data sensor and the surface of the recording medium are positioned for the data sensor to sense data.

Other features and benefits will be apparent upon reading the following detailed description and review of the associated drawings.

### BRIEF DESCRIPTION OF THE DRAWINGS

FIG. 1 is a schematic view of the use of the PPE lubricant in an interface between a data sensor and a surface of a recording medium.

FIG. 2 is a perspective view of a data storage system having ferroelectric storage media that is scanned by an array of probe tips.

FIG. 3 is perspective view of a disc drive.

FIG. 4 is a presentation of the general chemical structure of polyphenyl ether.

FIG. 5 is a graphical view comparing polyphenyl ether lubricant to other lubricants.

FIG. 6 is a graphical view illustrating signal amplitude maintenance over numerous write-read cycles.

### DETAILED DESCRIPTION

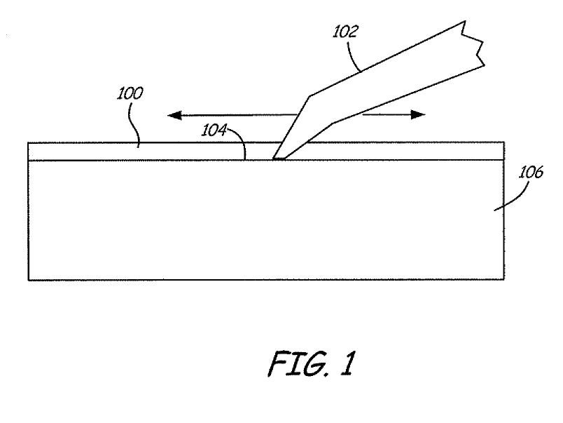

A layer 100 of polyphenyl ether lubricant for lubricating a probe tip 102 designed for contact with a surface 104 of a recording medium 106, is illustrated in FIG. 1. The use of polyphenyl ether as a lubricant between the probe tip 102 and the medium surface may be used in a myriad of write-read mechanical structures.

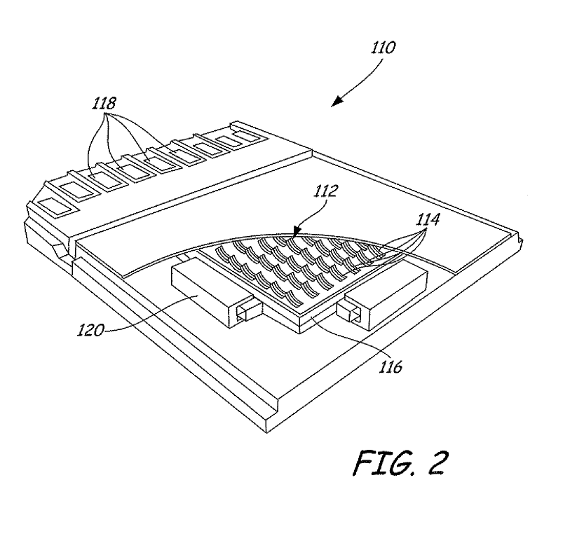

One such structure is a ferroelectric data storage device 110 as illustrated in FIG. 2. The data storage device 110 comprises a ferroelectric storage medium 116 with a scannable surface 112. The scannable surface 112 corresponds to the surface 104 of FIG. 1. An array of probes 114 contact the scannable surface 112 and communicate data to and from the scannable surface 112. The probes 114 each have probe tips 102. Micro actuators such as micro actuator 120 provide relative scanning motion between the scannable surface 112 and the probes 114. Electrical contacts 118 provide connections between the device 110 and a host computer system (not shown). The probes 114 sweep the surface 112 at such speed and proximity that a friction environment results.

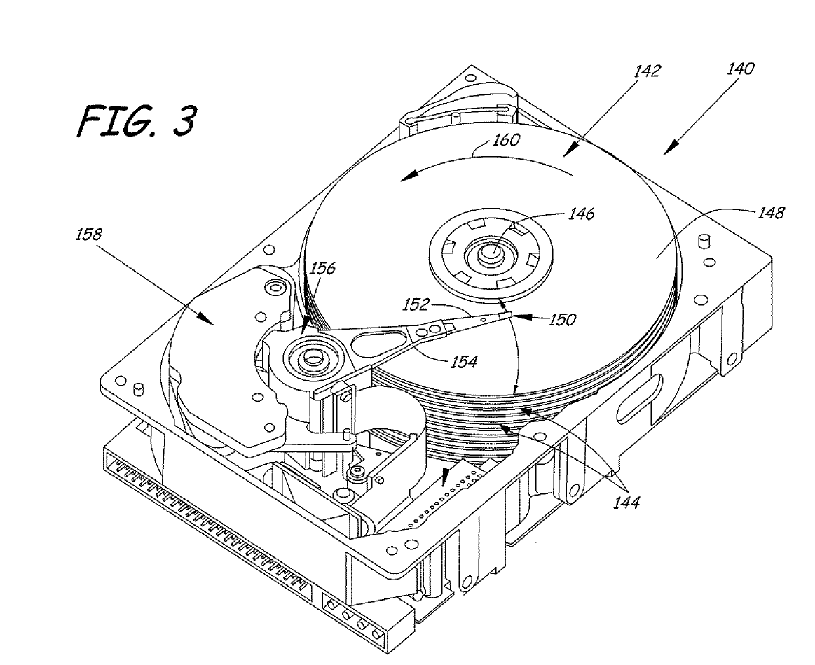

Another structure is used is a disc drive 140, as illustrated in FIG. 3. The disc drive 140 may include one disc or a disc pack 142 mounted on a spindle motor (not shown). In the case of the disc pack 142, the disc pack 142 includes a plurality of individual discs 144 which are mounted for co-rotation about a central axis 146. Each disc 144 has a disc surface 148 has an associated disc head slider 150 which is mounted to the disc drive for communication with the disc surface 148.

In the example illustrated in FIG. 3, the sliders 150 are supported by suspensions 152 which are in turn attached to track accessing arms 154 of an actuator 156. The actuator 156 is rotated by a voice coil motor 158 that rotates actuator 156 to position the slider 150 over a desired data track on the surface of an associated disc. An associated disc is also spinning in the general direction indicated by arrow 160, resulting in a high friction environment once the tip of the slider 150 is brought against the surface of the selected disc.

Other read-write structures that may be suitable include tape drives and optical discs.

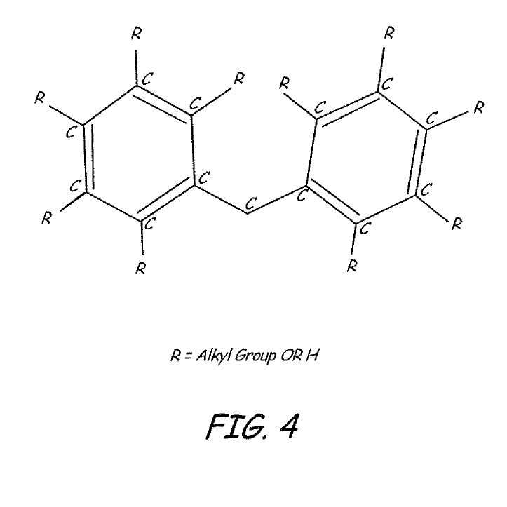

The use of polyphenyl ether lubricant decreases the interfacial friction between the probe tip 102 and the surface 104 of the medium 106. Polyphenyl ether is represented by the general chemical formula illustrated in FIG. 4, and suitable diphenyl ethers are described in U.S. Pat. No. 3,006,852 the entirety of which is hereby incorporated by reference. The polyphenyl ethers that are useful in the present invention are both unsubstituted and substituted polyphenyl ethers. Substituted polyphenyl ethers include those which are alkylated. Such alkylation is conducted in the presence of a catalyst during which alkyl groups, represented by R in FIG. 3 wherein R is of the general formula CₙH₂ₙ₊₁ where n is between 1 and 12, are substituted within the polyphenyl ether structure. Unsubstituted polyphenyl ethers include those with multiple aromatic rings and multiple ether linkages.

The polyphenyl ethers should not substantially decompose due to the shear caused by the contact pressure between the probe tip 102 and the surface of the medium 104. The geometry of the probe/medium contacting surface results in large contact pressures such as p=60 MPa−4 Gpa wherein p=pressure. Such large contact pressures facilitate high wear rates which polyphenyl ether lessens.

Polyphenyl ethers do not decompose even when experiencing high shear rates such as 3×10⁷ s⁻¹ to 3×10⁸ s⁻¹ that result from the movement in the mechanical interface between the tip 102 and the surface 104 of the medium 106. Polyphenyl ether which meets this criteria enables the very close association of the probe tip with the surface of the recording medium.

The polyphenyl ether also has to withstand high intermittent interfacial temperatures due to the contact pressure described above and the possibility of current flow. Such high interfacial temperatures are expected to run approximately >200° C. The polyphenyl ether lubricant does not substantially decompose (oxidize) under such high intermittent interfacial temperatures.

The polyphenyl ether also withstands current flow in the range of up to approximately 10 μA between the tip and the surface of the medium. Current flows of this magnitude do not substantially decompose or do not cause substantial polymerization of the polyphenyl ether. By substantially decompose is meant that the polyphenyl ether does not degrade sufficiently to affect its viscosity or lubricating characteristics. By substantially polymerize, it is meant that the polyphenyl ether does not further react with itself to a point where the functioning of the read-write capability of the probe is affected by a change in viscosity or other characteristics.

In practice, a broad range of contact pressures and sweep rates exist in the interface between the probe tip and the surface of the medium. Polyphenyl ether occurs in a broad range of viscosities. The viscosity of the polyphenyl ether will vary according to the degree or range of alkylation, the number of phenyl rings or ether linkages. Different viscosities may be needed to match the required viscosity for the appropriate functioning of the probe within the interface. The application of the polyphenyl ether to the media surface may be made via a multitude of methods.

The PPE is applied as a film to the media surface or the tip of the probe or both. Suitable methods of application include, for example, but are not limited to, solvent dilution, dipping, wiping or pressed to one or both of the contacting surfaces A suitable film thickness of the PPE ranges from 1 to 100 nanometers.

The PPE permits the tip of the probe to move through the PPE lubricant quickly enough to permit the tip to function properly in its write-read function in reading data from the surface of the recording medium. An effective time of descent through the PPE lubricant can be estimated by the following:

1/h²=1/h₀²+4Pt/3ηR²

where (h=the film thickness change, h₀=the initial film thickness, P=the applied pressure, η=the viscosity, R=the contact radius and t=the time of descent. The effective time of descent is dependent on the write or read requirements for the selected probe to be in contact with surface of the medium to sense data.

The following example which is intended for illustrative purposes only since numerous modifications and variations may be made.

### EXAMPLE

Polyphenyl ethers in alkylated form under the trade name OS-105, OS-124 and OS-137 were obtained from Arch Technology Holding LLC of St. Charles, Mo. The polyphenyl ethers were successfully applied at the head/media interface using several different methods. The media that the polyphenyl ethers were applied to was a ferroelectric surface of a probe storage system.

One method used to apply the polyphenyl ether was dip coating the media wafers using a dip coating system available from Nima Technology Ltd. of Coventry, England (Dipper Mechanism; type:D1L). Media wafers were immersed into a coating tank which contained 0.5% solution of OS-105 polyphenyl ether using hexane as a solvent to obtain a lubricant layer having a thickness of approximately 5 nanometers on the media surface. After immersion, the media wafers were withdrawn from the coating tank leaving the PPE lubricant on the media surface. During withdrawal from the tank, the hexane solvent was evaporated leaving the lubricant layer on the media surface.

Another method used to apply polyphenyl ether on a probe/media surface interface included applying droplets of polyphenyl ether which immersed the probe in the polyphenyl ether lubricant. Using this method, the polyphenyl ether lubricant was at a level that rose from the media surface up to the base of the probe at its point of attachment to the chip that controls the probe. Typically this distance may range from several micrometers to 100 micrometers. Two methods were used to apply the polyphenyl ether lubricant. One method was to apply the lubricant directly to the media surface and the other included applying a droplet of lubricant to the probe.

Another method used to apply the polyphenyl ether lubricant was by spraying a 0.5% polyphenyl ether in hexane solution using a nebulizer. The nebulizer used is described in the Jacobs U.S. Pat. No. 6,475,570, the entirety of which is hereby incorporated by reference. After the solution was sprayed and the solvent evaporated, the surface of the media was covered by a thin layer of pure polyphenyl ether lubricant.

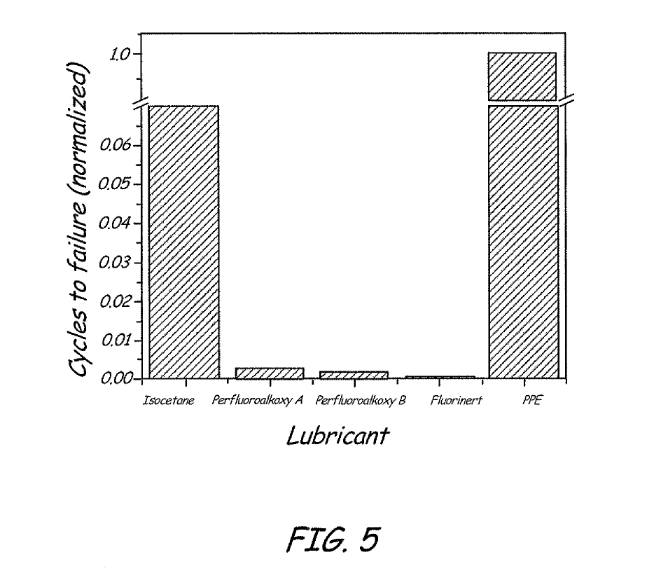

All cases described in this example, after application of the polyphenyl ether lubricant, the probe tip and surface media were brought into contact and the probe storage device was tested for write-read performance in the presence of the polyphenyl ether lubricant at the interface. During the write-read function, the signal obtained was analyzed for failures. As shown in FIG. 5 the addition of the polyphenyl ether lubricant dramatically delays wear and thus failures on the surface of the media. FIG. 5 shows a comparison to other lubricants tested in the same fashion as discussed above showing superiority of the polyphenyl ether lubricant.

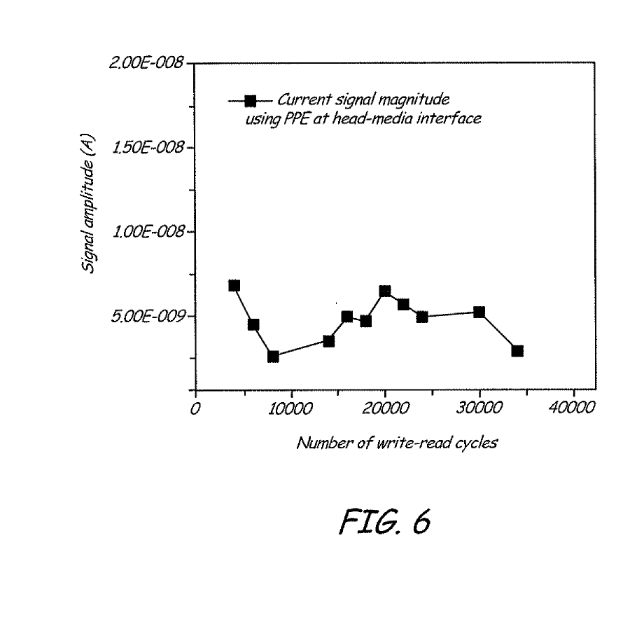

FIG. 6 shows current amplitude during the write-read cycles using polyphenyl ether lubricant. The signal magnitude (amplitude) maintains a satisfactory value for good performance of the probe storage device which reflects that the wear rate of the interface is very low and there is no degradation of the polyphenyl ether lubricant.

It is to be understood that even though numerous characteristics and advantages of various aspects have been set forth in the foregoing description, together with details of the structure and function of various aspect, this disclosure is illustrative only, and changes may be made in detail, especially in matters of structure and arrangement of parts to the full extent indicated by the broad general meaning of the terms in which the appended claims are expressed. For example, the particular elements may vary depending on the particular application for the polyphenyl ether system while maintaining substantially the same functionality. In addition, although the preferred aspects described herein are directed to a polyphenyl ester system for use as a lubricant in a probe interface, it will be appreciated by those skilled in the art that the teachings described herein can be applied to other mechanical sensing structures.

What is claimed is:

1. A data sensing interface comprising:
a surface of a recording medium;
a tip of a data sensor positioned to sense data stored on the recording medium; and
a layer of polyphenyl ether disposed between the tip and the surface to function as a lubricant.

2. The interface of claim 1 wherein the polyphenyl ether is an alkylated polyphenyl ether.

3. The interface of claim 1 wherein a polyphenyl ether is capable of withstanding shear rates in the range of approximately 3×10⁷ s⁻¹ to 3×10⁸ s⁻¹.

4. The interface of claim 1 wherein the polyphenyl ether is capable of withstanding current flow of up to approximately 10 μA without substantially degrading.

5. The interface of claim 1 wherein the polyphenyl ether is capable of withstanding current flow of up to approximately 10 μA without substantially polymerizing.

6. The interface of claim 1 wherein the polyphenyl ether is capable of withstanding current flow of up to approximately 10 μA without substantially increasing in viscosity.

7. The interface of claim 1 wherein the polyphenyl ether is capable of withstanding intermittent temperatures equal to or exceeding approximately 200° C. without substantial decomposition.

8. A method of reducing wear within a data sensing interface, the method comprising;
providing a layer of polyphenyl ether between a tip of a data sensor and surface of a recording medium such that the polyphenyl ether acts as a lubricant wherein the tip of the sensor and the surface of the recording medium are positioned for the data sensor to sense data.

9. The interface of claim 8 wherein the polyphenyl ether is an alkylated polyphenyl ether.

10. The interface of claim 8 wherein the polyphenyl ether is capable of withstanding shear rates in the range of approximately 3×10⁷ s⁻¹ to 3×10⁸ s⁻¹.

11. The interface of claim 8 wherein the polyphenyl ether is capable of withstanding current flow of up to approximately 10 μA without substantially degrading.

12. The interface of claim 8 wherein the polyphenyl ether is capable of withstanding current flow of up to approximately 10 μA without substantially polymerizing.

13. The interface of claim 8 wherein the polyphenyl ether is capable of withstanding current flow of up to approximately 10 μA without substantially increasing in viscosity.

14. The interface of claim 8 wherein the polyphenyl ether is capable of withstanding intermittent temperatures equal to or exceeding approximately 200° C. without substantial decomposition.

15. A storage device comprising:
at least one scannable surface of recording medium;
at least one data sensor positioned to sense data stored on the recording medium; and
a layer of polyphenyl ether disposed between the data sensor and the surface of the recording medium to function as a lubricant between the data sensor and the recording medium.

16. The device of claim 15 wherein the at least one data sensor includes an array of data sensors.

17. The device of claim 15 wherein the polyphenyl ether is an alkylated polyphenyl ether.

18. The device of claim 15 wherein the polyphenyl ether is capable of withstanding shear rates in the range of approximately 3×10 s⁻¹ to 3×10⁸ s⁻¹.

19. The device of claim 15 wherein the polyphenyl ether is capable of withstanding current flow of up to approximately 10 μA without substantially degrading.

20. The device of claim 15 wherein the polyphenyl ether is capable of withstanding current flow of up to approximately 10 μA without substantially polymerizing.

21. The device of claim 15 wherein the polyphenyl ether is capable of withstanding current flow of up to approximately 10 μA without substantially increasing in viscosity.

22. The device of claim 15 wherein the polyphenyl ether is capable of withstanding intermittent temperatures equal to or exceeding approximately 200° C. without substantial decomposition.
